(19) United States
(12) Patent Application Publication
(10) Pub. No.: US 2005/0021620 A1
(43) Pub. Date: Jan. 27, 2005

(54) Web data conferencing system and method with full motion interactive video

(76) Inventors: Todd Simon, Bensalem, PA (US); John Lytle, Collegeville, PA (US)

Correspondence Address: RATNERPRESTIA, P O BOX 980, VALLEY FORGE, PA, 19482-0980, US

(21) Appl. No.: 10/661,863

(22) Filed: Sep. 12, 2003

Related U.S. Application Data
(60) Provisional application No. 60/474,314, filed on May 30, 2003.

(51) Int. Cl. G06F 15/16

(52) U.S. Cl. 709/204

(57) ABSTRACT

A web data conferencing system is coupled to a video server to provide the output video signal of the video server as the video portion of the web conference. The video server is configured to receive video signals from multiple sources and to interactively provide the video signals as an output signal to the web conference.

### CROSS-REFERENCE TO RELATED APPLICATIONS

This application claims the benefit of U.S. Provisional Application No. 60/474,314, filed May 30, 2003, the contents of which are incorporated herein by reference.

### TECHNICAL FIELD

The present invention relates, in general, to web data conferencing systems and, in particular, to a web data conferencing system that includes full motion interactive video conferencing features.

### BACKGROUND OF THE INVENTION

Multi-point motion video conferencing systems in which motion pictures are communicated, by way of a network, among multiple terminals, respectively installed at remote locations from each other, are known in the field. One such conference system is disclosed by Shibata et al. in U.S. Pat. No. 5,446,491, issued on Aug. 29, 1995, and is briefly discussed below.

Shibata et al. disclose a multi-point motion video conferencing system having terminals disposed at four locations. The four terminals communicate with each other by way of a packet network, which establishes connections for motion pictures sent from one terminal to the other terminals. Each terminal includes a video camera, a display, an encoder and a decoder. Each terminal, on its transmitting side, uses a video camera to produce a motion picture. Data of the motion picture produced by the video camera is subjected to compression by the encoder, which establishes a match between the data of the motion picture and the network. The data thus compressed is divided into smaller units called packets, which are sequentially transmitted to the network.

On the receiving side of the terminal, the packets transmitted from other terminals are received by the decoder, so as to rebuild, or decompress the original motion picture. The decompressed motion picture is then presented on the display for viewing by a participant, located at the terminal.

The encoder and decoder of each terminal may be implemented in conformity with an algorithm described in recommendation H.261 for video encoding method standards of the International Telecommunication Union-Telecommunication Standardization Sector (ITU-TS). The encoder and decoder may also be implemented in conformity with ITU-TS recommendations H.263 and H.264.

The system of Shibata et al. operates each decoder of a respective terminal in a time division multiplexing mode, so that several compressed images received from different terminals may be displayed on one display for viewing by a participant. As a result, as the number of terminals involved in the video conferencing system increases, the amount of data to be calculated and processed by the decoder increases proportionately.

Another multi-point motion video conferencing system is disclosed by Lee in U.S. Pat. No. 6,195,116, issued on Feb. 27, 2001. Lee discloses a system similar to Shibata et al. including a multi-point controller (MCP) that controls the remote terminals. Each of the terminals encodes only certain objects of a photographed picture, by removing background images and other non-object images from the photographed picture and transmitting the encoded image signal to the multi-point controller. The object encoded and transmitted corresponds to a conference participant.

Each of the terminals, disclosed by Lee, receives a synthesized image signal and decodes such signal to display a superimposed image. The synthesized image signal is a signal resulting from superimposing object image signals from the terminals with a background image signal. As disclosed by Lee, the MCP receives and decodes encoded object image signals from the terminals, adjusts the size of each object image according to the number of participants participating in the video conferencing, synthesizes the size-adjusted object images and the separately generated background image, and compression-encodes the synthesized data to simultaneously transmit the compression-encoded images to the terminals. The MCP is constructed using the network by a network operator.

Still another multi-point video conferencing system is disclosed by Watanabe et al. in U.S. Pat. No. 6,198,500, issued on Mar. 6, 2001. This system includes multiple conference terminals coupled to each other, by way of a MCU. Image data and voice data are transmitted among the terminals so that participants at the terminals are in conference with each other. The MCU distributes image data from each conference terminal to other conference terminals. A participant who speaks is selected and the MCU distributes image data and voice of the speaker to the other participants. To a conference terminal of the speaker, image data of speakers other than the speaker are transmitted. In this manner, a participant at one terminal may view and hear the participants at the other terminals.

The above discussion included multi-point video conferencing systems, in which participants located at different terminals may actively, or interactively communicate in real-time with each other. In a different, but related field, web conferencing is used to deliver video and audio data over a network to participants located at different terminals, who may passively view and listen to a remote speaker.

A typical web conference involves a speaker at one remote location and a relatively large number of participants located at respective computer terminals. In general, many participant computer terminals are connected to a wide area network (WAN) or a local area network (LAN) to view the speaker, and use phones that are connected to a POTS (Plain Old Telephone Service) network for listening to the speaker.

When the speaker is presenting, the speaker usually generates visual, audio, and textual data, any or all of which may be captured by the system. A camera captures video of the speaker and a microphone captures audio of the speaker's voice. A keyboard and/or mouse, connected to the speaker's computer captures slide-flip commands from the speaker. Slide-flip commands are requests to move to a new slide and alerts to the participants to display the new slide.

The speaker's computer executes an encoder program that processes and synchronizes the data streams, associated with the capture of data by the various input sources. The encoder program uses a clock to sequence through units of data captured by each input source and synchronizes each separate stream of data. The video data stream is sent via a wide area network, for example, to the participant's local computer for display. The audio data stream is sent via POTS to the participant's local telephone. In this manner, the participant may view and hear the remote speaker.

An example of a web data conferencing system is disclosed in U.S. Patent Application Publication No. 2002/0112004, published on Aug. 15, 2002.

A disadvantage of a web data conferencing system is that the participants may only passively watch a speaker. These participants, typically cannot become active speakers, so that they also may be watched by other participants in the web conference.

A disadvantage of a multi-point video conferencing system is that, as more participants become speakers in the system, the MCU becomes proportionately more complicated and more costly.

The present invention addresses overcoming these disadvantages by integrating both of the above systems together, namely, integrating a multi-point video conferencing system (also referred to as a video conferencing system) with a web conferencing system. As will be explained, the invention advantageously allows multiple speakers, who are remotely located from each other, to interactively participate in a multi-point video conference and, simultaneously, in real-time, multiple participants may view all these multiple speakers on their respective terminals.

### SUMMARY OF THE INVENTION

To meet this and other needs, and in view of its purposes, the present invention is embodied in a web data conferencing system that is coupled to a video server to provide the output video signal of the video server as the video portion of the web conference.

According to one aspect of the invention, the video server is configured to receive video signals from multiple sources and to interactively provide the video signals as an output signal to a web conferencing system.

According to another aspect of the invention, a web data conferencing system includes means for receiving a full-motion video signal from a remote location; means for providing the full-motion video signal to a web conferencing system; and a network interface for providing the full-motion video signal to a plurality of web conference subscribers. The means for providing the full motion video signal to the web conferencing system may include a format converter that converts the full-motion video signal into a format compatible with a web conferencing signal. The means for receiving the full-motion video signal from the remote location may include a plurality of coder/decoders (codecs) and a video server, wherein the video server is configured to combine video signals provided by the respective codecs to generate the full-motion video signal.

According to yet another aspect of the invention, a web data conferencing system includes a video server for receiving a full-motion video signal from a remote location; and a processor coupled to the video server for converting the full-motion video signal into a format compatible with a web conferencing system. The processor is configured to communicate with a first network, and the video server is configured to communicate with a second network. The first network is independent of the second network. The full-motion video signal may include full-motion interactive images of a plurality of participants communicating among each other over the second network, and the processor may be configured to transmit the converted full-motion video signal to another plurality of participants communicating over the first network. The video server may provide a portion of the full-motion video signal as an audio signal to the other plurality of participants by way of a third network. The third network may be independent of the first and second networks.

According to still another aspect of the invention, a web conferencing method is provided. The method includes the steps of: (a) receiving a full-motion video signal from a remote location; (b) converting the full-motion video signal into a format compatible with a web conferencing system using a web conferencing signal; and (c) transmitting the converted full-motion video signal to web conference participants. The method may also include the following additional steps: (d) extracting a sound signal after receiving the full-motion interactive images in step (a); and (e) transmitting the extracted sound signal to the web conference participants using a first network independent of a second network for transmitting the converted full-motion video signal to the web participants.

It is understood that the foregoing general description and the following detailed description are exemplary, but are not restrictive, of the invention.

### BRIEF DESCRIPTION OF THE DRAWING

The invention is best understood from the following detailed description When read in connection with the accompanying drawing. Included in the drawing are the following figures:

FIG. 1 is a schematic diagram of a web conferencing system having full-motion interactive video, according to one embodiment of the present invention;

FIG. 2 is a schematic diagram of the video conversion apparatus used in the system shown in FIG. 1;

FIG. 3 is a schematic diagram of a web conferencing system which is configured to receive full-motion interactive video, according to another embodiment of the present invention;

FIG. 4 is a schematic diagram of a web conferencing system having full-motion interactive video, according to still another embodiment of the present invention;

FIG. 5 is a schematic diagram of a web conferencing system having full-motion interactive video, according to yet another embodiment of the present invention;

FIG. 6 is a schematic diagram of a web conferencing system having full-motion interactive video, according to a further embodiment of the present invention; and

FIG. 7 is a schematic diagram of a web conferencing system having full-motion interactive video, according to a still further embodiment of the present invention.

### DETAILED DESCRIPTION OF THE INVENTION

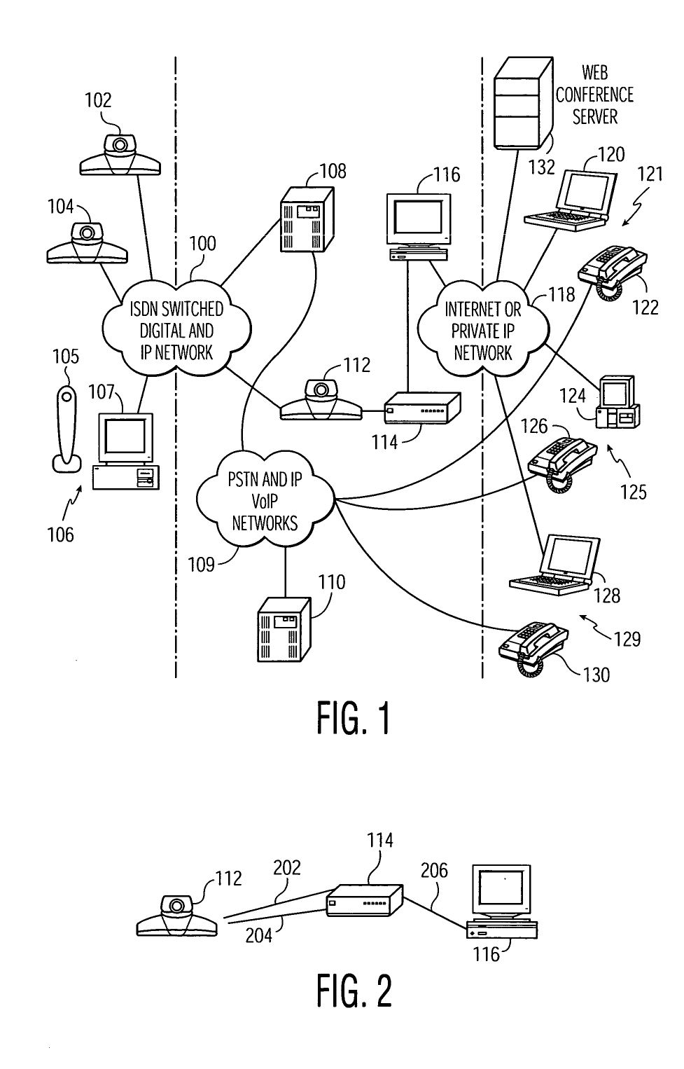

FIG. 1 is a schematic diagram of a web conferencing system according to the present invention. The apparatus shown in FIG. 1 includes components of a web conferencing system and components of a video conferencing system (also referred to as a multi-point video conferencing system). In the exemplary embodiment of the invention, the video signal provided by the video conferencing system is used as the video signal for the web conferencing system to implement a web conferencing system having interactive full-motion video.

The video conferencing components shown in FIG. 1 include three full-motion video camera systems 102, 104 and 106 each with its associated encoder/decoder (codec). In the materials that follow, these are referred to as codecs. The codecs 102 and 104 are stand-alone units that include a camera, a codec and an interface to a network 100. For the codec 106, the camera 105 is a separate unit, coupled to a workstation 107 that includes a software codec. The exemplary codecs may conform to any of the H.261, H.263 or H.264 video protocols and the G.711, G.722, G.728, G.722.1, Siren 7 or Siren 14 audio protocols. In addition, the codecs may employ compression according to the H.320, H.323, H.324, MPEG-1, MPEG-2 or MPEG-4 protocols.

The workstation 107 In the exemplary embodiment of the invention, also includes an interface to the network 100. The exemplary network 100 may be an integrated services digital network (ISDN), including broadband ISDN (BISDN) or an Internet protocol (IP) network. The network may be wireless or wired (including fiber-optic components) and may be a local area network (LAN) or a wide area network (WAN). It is contemplated that the network 100 may also be a global information network (e.g. the Internet or Internet2).

In the exemplary embodiment of the invention, the codecs 102, 104 and 106 each provides both image data and voice data through the network 100 to a video server 108 which may be configured as a video bridge or video gateway. The video server 108 desirably conforms to the same protocol or protocols used by the codecs 102, 104 and 106, described above. Video server 108 may also function as a multi-point controller (MCP), functioning to facilitate communications among individuals or participants at different locations. Accordingly, at least one of the codecs 102, 104 and 106 is in a location that is remote from the video server 108. The video server 108 may provide both audio and video signals, through the network 100 to video monitors (not shown) associated with each of the codecs 102, 104 and 106. If, as described below, the persons using the codecs 102, 104 and 106 are also subscribers to the web conference, the video monitors may be eliminated.

In the exemplary embodiment of the invention, the video server 108 also provides a video signal, through the network 100, to a codec 112 and provides audio signals to an audio server 110. In the exemplary embodiment, the audio signals may be provided via the public switched telephone network (PSTN), an IP network or a voice over IP (VoIP) network 109.

The video signals processed by the video server 108 are used to provide an interactive video conference to the participants using the codecs 102, 104 and 106 and, as described below, also to the participants of a more widely subscribed web conference. The video conference is interactive in that the image presented via the video signal may be changed interactively, for example in response to the corresponding audio signal. In this example, as each of the participants at the codecs 102, 104 and 106 speaks, his or her image and voice are transmitted to the other participants.

In the exemplary embodiment of the invention, the audio signal provided by the video server 108 to the audio server 110 is the master audio signal of a web conference. The web conference apparatus also includes several stations each including a computer and a telephone. In the exemplary embodiment of the invention, station 121 includes a laptop computer 120 and a telephone 122; station 125 includes a desktop computer 124 and a telephone 126; and station 129 includes a laptop computer 128 and a telephone 130. Each of the telephones 122, 126 and 130 is connected to the audio server 110 via the PSTN, IP or VoIP network 109. In addition, each of the computers 120, 124 and 128 is connected to a web conference computer 116 via a network 118. In the exemplary embodiment of the invention, the network 118 may be a wireless or wired private IP network (either LAN or WAN) or may be a global information network such as the Internet or Internet2. Web conference server 132 controls dissemination of video and other data from web conference computer 116, via network 118, to the other participants, such as stations 121, 125 and 129.

The physical layers of the networks 100, 109 and 118 may be, for example, Q.931 (ISDN-PRI and BRI), Switched Digital T-1, Switched Digital 56 kps, PSTN, IP (including ATM, Sonet, MPLS, Ethernet (10/100/1000), xDSL, Cable Television (CATV) network or other physical system that is compatible with IP), Satellite and/or a dedicated connected network including wired, wireless and/or optical components.

In addition to providing the audio signal to the network 109, the video server 108 also provides the video signal from the video conference to a codec 112. This codec converts the video signal to an analog signal (e.g. NTSC, PAL, SECAM, analog component video or S/Video). The output signal of the codec 112 is applied to a format converter 114 which converts the video signal to a format that is compatible with the web-conferencing computer 116 and provides the converted signal to the computer 116 via a USB port, for example. In the exemplary embodiment of the invention, the format converter 114 provides the video signal according to a protocol such as JPGL, VCF, OCF or PGB, for example.

In this configuration, the interactive video conference generated using the codecs 102, 104 and 106 is broadcast to the subscribers of the web conference using the stations 121, 125 and 129. It is contemplated that the video conference may be the entire web conference or that it may be a video portion of the web conference in addition to a data portion (e.g. a slide presentation, spread sheet or electronic document). The data portion, if it exists, may be controlled from the web-conferencing computer 116. In the configuration described above, the web conference subscribers receive the video portion of the web conference from the computer 116 but receive the audio portion from the audio server 110, for example, as a part of a conventional teleconference.

In an alternative embodiment of the invention, both the audio and video portions of the video conference may be provided to the web conference subscribers via the web conference computer 116. In this alternative embodiment, the connection between the video server 108 and the audio network 109 is optional; the codec 112 may receive both the audio and video portions of the video conference from the video server 108 via the network 100.

FIG. 2 is a schematic diagram that illustrates details of the codec 112, format converter 114 and web conferencing computer 116. In one exemplary embodiment of the invention, the codec 112 provides analog video signals, via a connection 202, and analog audio signals via a connection 204 to the format converter 114. The converter 114 processes these signals to obtain signals according to the exemplary JPGL, VCF, QCF or PGB protocol which are applied to the web conferencing computer 116 to be distributed to the web conference subscribers. In one exemplary embodiment of the invention, the format converter may be a USB VideoBus II system manufactured by Belkin.

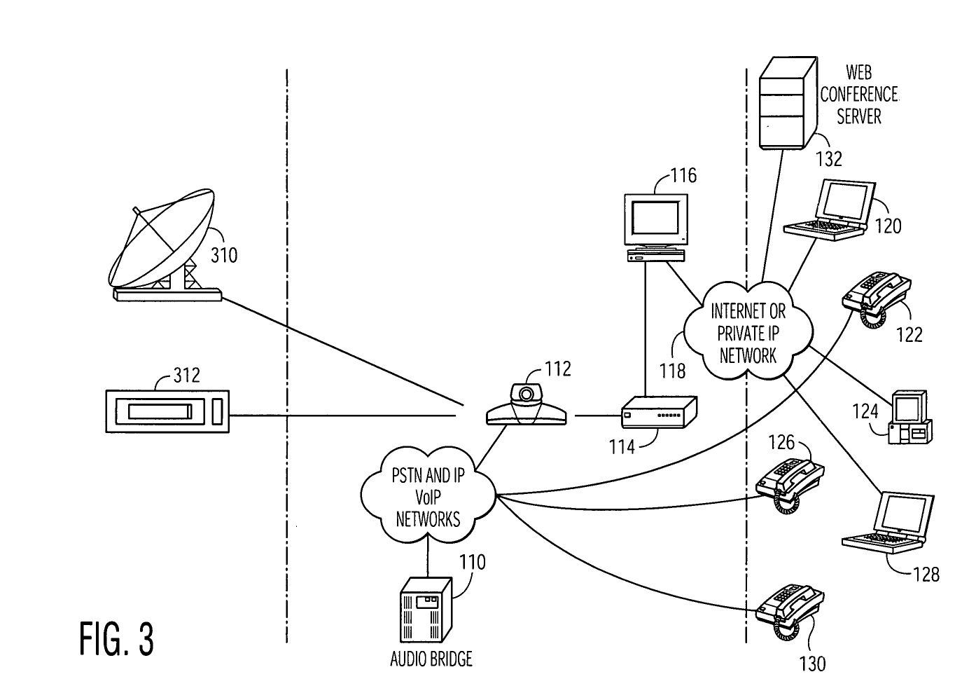

FIG. 3 is a schematic diagram of another exemplary embodiment of the invention in which the video-conference input to the web conferencing computer 116 is replaced by a video feed from, for example, a satellite receiver 310 or a video play-back device 312. The video playback device may be, for example, a CD, DVD, VCR, video tape recorder, personal video recorder or other video playback device.

In this alternative embodiment, the digital video and audio signal from the source 310 or 312 is applied directly to the codec 112 which, in one embodiment of the invention, separates the audio signal and provides it to the audio server 110 via the network 109 and, in another embodiment of the invention, provides the audio signal to the format converter 114, as described above with reference to FIG. 2. The codec 112 also provides the analog video signal to the format converter 114 which, as described above converts the analog video signal and, optionally the analog audio signal, into corresponding digital signals according to the exemplary JPGL, VCF, QCF or PGB protocol. These signals are provided to the web conferencing computer 116, as described above to be broadcast, as the video portion of the web conference signal, to all of the web conference subscribers.

In another alternative embodiment, the video server 108 (shown in FIG. 1) may be connected to the web conferencing computer 116, for example, by a transcoder (not shown) which converts the video and audio signals provided by the video server 108 into a format compatible with the web conferencing computer 116 without first converting it to an analog signal. This transcoder may be a separate hardware device or it may be implemented in software on either the video server 108 or the web conferencing computer 116. It is contemplated that no transcoder may be needed if the protocol used for the video and audio portions of the web conferencing computer 116 is compatible with the protocol(s) used by the video server 108. It is further contemplated that the video server and the web conferencing computer may be implemented in a single computer such that the interactive video images processed by the video server are configured to be the video portion of the web conference.

Referring again to FIG. 1, codecs 102, 104, 106 and 112 may each be a codec manufactured by Polycom, Sony, Tandberg, PictureTel, VTEL or VCON, for example. An exemplary codec may be View Station 512 manufactured by Polycom.

Video server 108, when configured as a video bridge/gateway, may be a MGC-100 manufactured by Polycom, for example. Audio server 110, for example, may be a ML-700 manufactured by Spectel.

Format converter 114, which converts the analog decompressed video signal to a digital signal compatible with web conferencing computer 116, may be a Belkin USB Videobus II system, for example. Web conferencing computer 116 may be any personal computer (PC) employing a Windows/Intel based architecture.

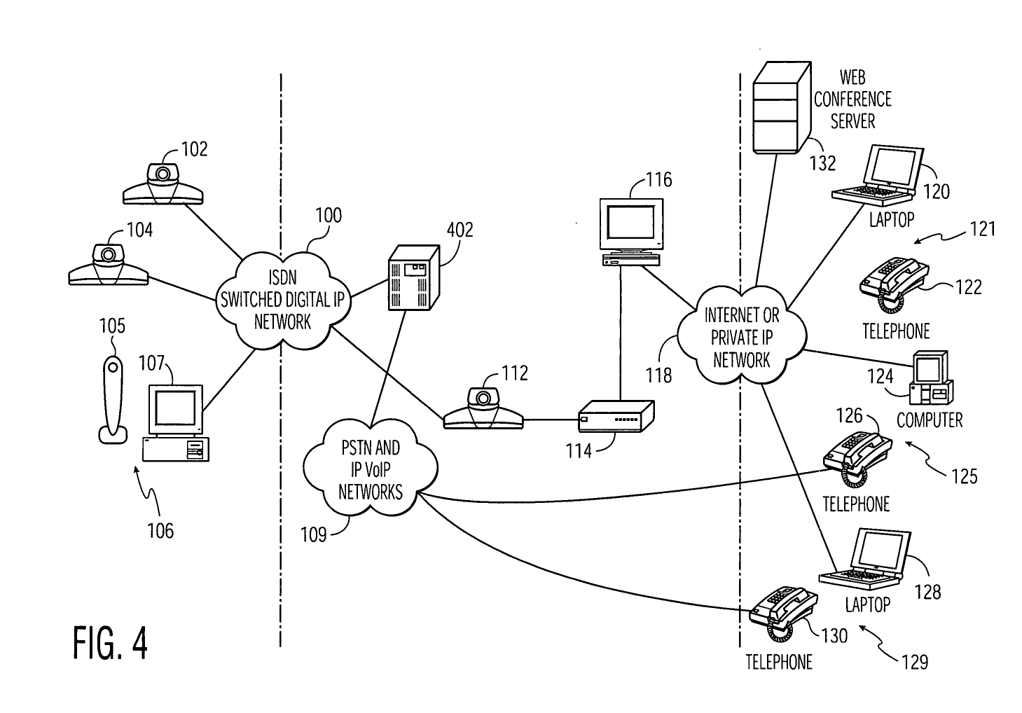

Another embodiment of the invention is shown in FIG. 4. The embodiment shown in FIG. 4 is similar to FIG. 1, in which similar reference numerals denote similar components.

As shown, the functions of video server 108 and audio server 110 of FIG. 1 are combined into a single unit including video/audio server 402. Video/audio server 402 provides a video signal, through network 100, to codec 112 and provides audio signals, through network 109, to participants' telephones. Network 109, for example, may be a PSTN, an IP or a VoIP network.

Elements 402, 112, 114 and 116, shown in FIG. 4, may be co-located in one room or may reside at a single location. In this manner, control and maintenance of the entire interface (elements 402, 112, 114 and 116) between the full-motion video conference (elements 102, 104 and 106) and the web conference (elements 132, 121, 125 and 129) are readily and easily accomplished.

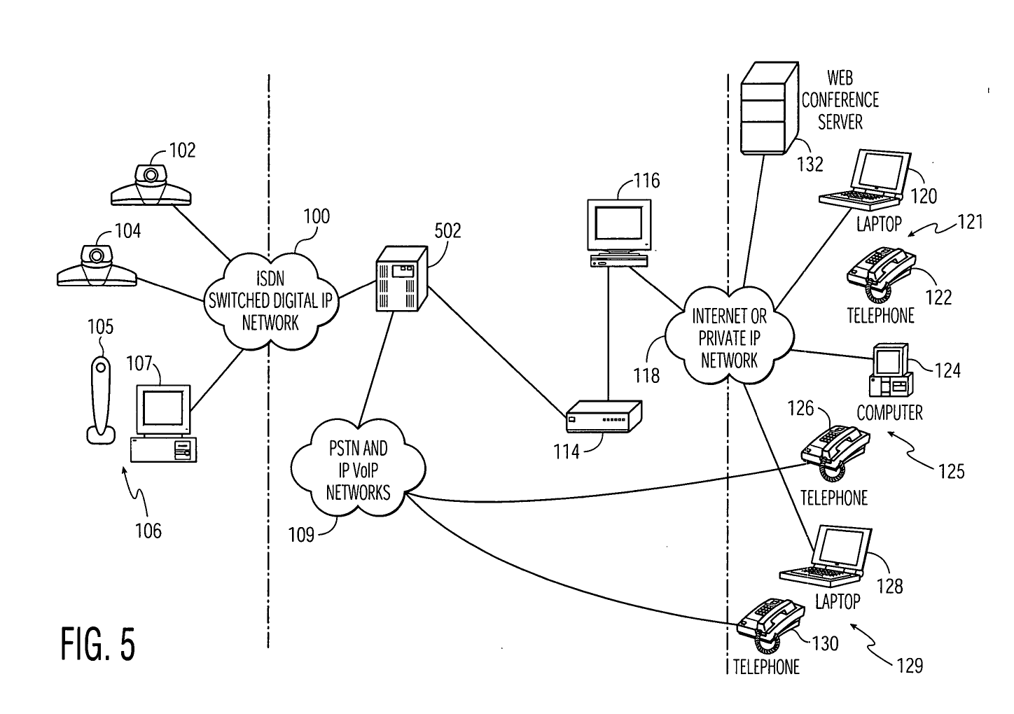

Yet another embodiment of the invention is shown in FIG. 5. The embodiment shown in FIG. 5 is similar to the embodiment shown in FIG. 4, except that server 502 formats the video signal into an analog decompressed video signal. Codec 112 (shown in FIG. 4) is eliminated from this embodiment, since the function of codec 112 is performed by server 502. Thus, server 502 may have functions of a MCU and a decoder for decompressing the video signal.

By directly connecting server 502 to format converter 114, the analog decompressed video signal provided by server 502 is converted into a format compatible with web conferencing computer 116. Server 502 also provides audio signals to network 109, which may be a PSTN, an IP or a VoIP network.

Elements 502, 114 and 116, shown in FIG. 5, may be located in one room or at a single location. These elements are effective in combining a full motion interactive video (communications through network 100 between multiple speakers using codecs 102, 104 and 106, for example) with multiple web participants (receiving communications from server 132 through network 118 using stations 121, 125 and 129, for example).

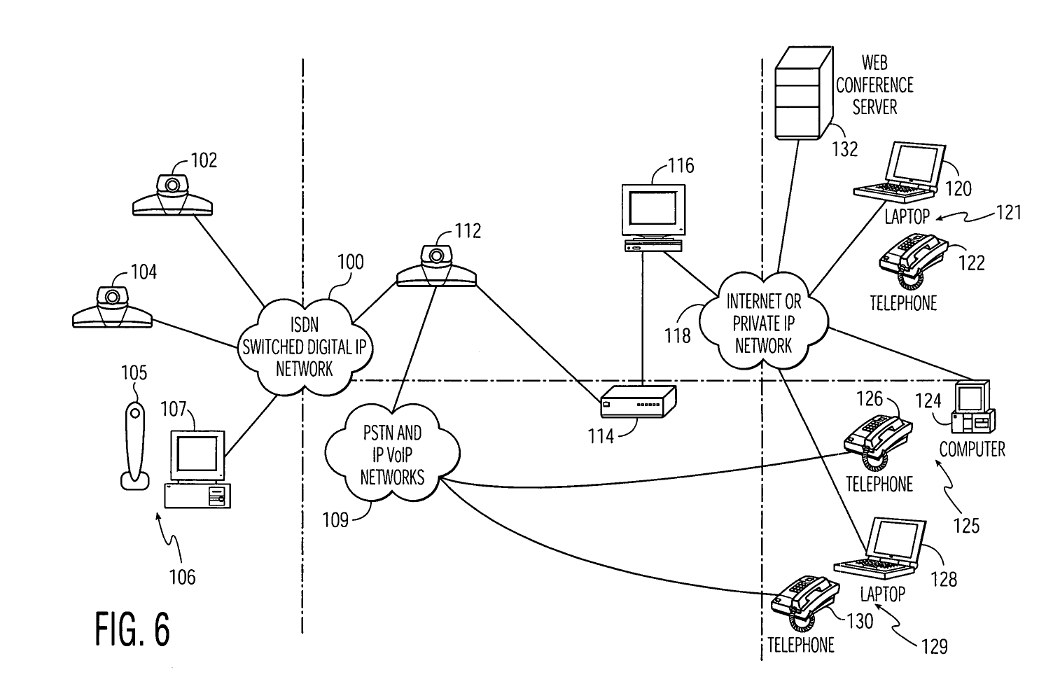

Still another embodiment of the invention is shown in FIG. 6. The embodiment shown in FIG. 6 eliminates server 402 of FIG. 4. As shown, codec 112 receives the full motion interactive video occurring among codecs 102, 104 and 106 (for example) by way of network 100. It will be appreciated that the function of the MCU may be located elsewhere (not shown). Codec 112 converts the video signal into an analog signal (e.g. NTSC, PAL, SECAM, analog component video or S/video). The decompressed analog signal is applied to format converter 114 which converts the video signal into a format compatible with web conferencing computer 116. Web conference server 132 receives the video signal from computer 116 and broadcasts the video signal to subscribers of the web conference at stations 121, 125 and 129 (for example).

It will be appreciated that the web conference subscribers (participants) receive the video portion of the interactive video conference from computer 116, and the audio portion from network 109. Network 109, in turn, receives the audio signals from codec 112, as shown in FIG. 6. Codec 112, of course, includes, as output signals, the decompressed audio signal and the decompressed video signal.

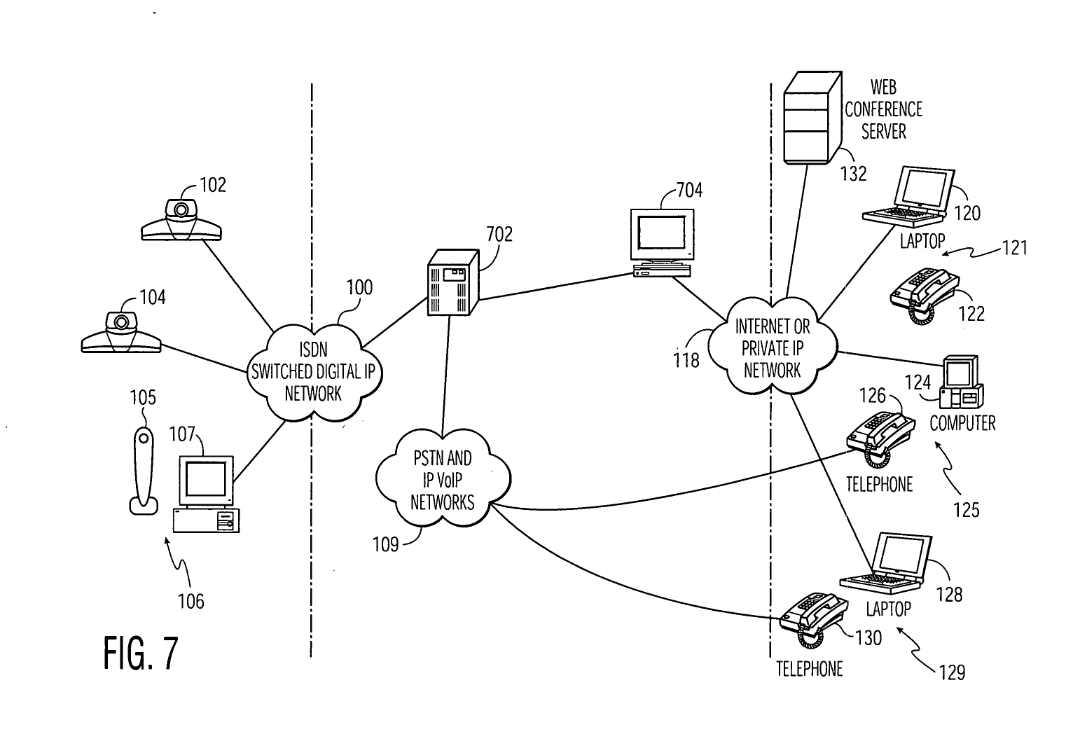

Another embodiment of the invention is shown in FIG. 7. As shown, this embodiment is similar to the embodiment shown in FIG. 5, except that the function of format converter 114 is eliminated. Server 702 provides the video signal, received from the speakers in the video conferencing system in a first digital format to computer 704. Computer 704 includes software for converting the first digital format into a second digital format compatible with web conference server 132. Computer 704 may include a digital video card to convert the first digital format into the second digital format.

It is further contemplated that server 702 and computer 704 may be implemented in one single computer, such that the interactive video images processed by server 702 may be configured to be the video portion of the web conference.

While the invention has been described in terms of exemplary embodiments, it is contemplated that it may be practiced with variations that are within the scope of the following claims.

1. A web data conferencing system comprising:
means for receiving a full-motion video signal from a remote location;
means for providing the full-motion video signal to a web conferencing system; and
a first network interface for providing the full-motion video signal to a plurality of web conference subscribers as a web conferencing signal.

2. A web conferencing system according to claim 1, wherein the means for providing the full motion video signal as the web conferencing signal includes a format converter which converts the full-motion video signal into a format compatible with the web conferencing system.

3. A web conferencing system according to claim 1, wherein the means for receiving the full-motion video signal from the remote location includes a plurality of coder/decoders (codecs) and a video server, wherein the video server is configured to combine video signals provided by the respective codecs to generate the full-motion video signal.

4. A web conferencing system according to claim 1, wherein the means for receiving the full-motion video signal from the remote location includes a plurality of codecs, a video/audio server and an audio server,
the video/audio server is configured to receive video and audio signals provided by the respective codecs to generate a video portion of the full-motion video signal, and
the audio server is configured to communicate with the video/audio server for receiving the audio signals to generate an audio portion of the full-motion video signal.

5. A web conferencing system according to claim 4, wherein the first network interface is configured for compatibility with one of a global information network and a private Internet protocol (IP) network, and
a second network interface provides the audio signals between the video/audio server and the audio server, the second network interface is configured for compatibility with one of a public switched telephone network (PSTN), IP network, and voice-over-IP (VoIP) network.

6. A web conferencing system according to claim 1, wherein the means, for receiving the full-motion video signal from the remote location includes
a second network interface for receiving the full-motion video signal from one of an integrated switched digital network (ISDN) network and an IP network, and
the second network interface is independent of the first network interface.

7. A web conferencing system according to claim 1, wherein the means for providing the full-motion video signal to the web conferencing system includes
a format converter coupled to one of the plurality of codecs for converting the full-motion video signal into a digital signal compatible with the web conferencing signal, and
the first network interface coupled to the format converter for receiving the digital signal and providing the digital signal to the plurality of web conference subscribers.

8. A web conferencing system according to claim 7, wherein the one of the plurality of codecs converts the full-motion video signal into an analog signal having a format of one of NTSC, PAL, SECAM, analog component video and S/Video.

9. A web conferencing system according to claim 1 wherein the means for receiving the full-motion video signal from the remote location includes a plurality of coder/decoders (codecs) and a video server, wherein the video server is configured to combine video signals provided by the respective codecs to generate the full-motion video signal, and
the means for providing the full motion video signal to the web conferencing system includes a format converter which converts the full-motion video signal into a format compatible with the web conferencing signal.

10. A web conferencing system according to claim 1 wherein the means for receiving the full-motion video signal from the remote location includes
a codec for receiving the full-motion video signal from one of a video play-back device and a video feed from a satellite receiver, the codec configured to decompress the received full-motion video signal to produce an analog video signal, and
a format converter coupled to the codec for converting the analog video signal into a format compatible with the web conferencing signal.

11. A web data conferencing system comprising:
a video server for receiving a full-motion video signal from a remote location; and
a processor coupled to the video server for converting the full-motion video signal into a format compatible with the web conferencing signal;
wherein the processor is configured to communicate with a first network,
the video server is configured to communicate with a second network, and
the first network is independent of the second network.

12. A web conferencing system according to claim 11 wherein
the full-motion video signal includes full-motion interactive images of a plurality of participants communicating with each other over the second network, and
the processor is configured to transmit the converted full-motion video signal to another plurality of participants communicating over the first network.

13. A web conferencing system according to claim 12 wherein
the video server provides a portion of the full-motion video signal as an audio signal to the other plurality of participants by way of a third network, and
the third network is independent of the first and second networks.

14. A web conferencing system according to claim 11 including
a codec and a format converter serially connected to each other between first and second ends,
the first end connected to the processor, and
the second end coupled to the video server by way of the second network,
wherein the codec converts the full-motion video signal into an analog signal, and
the format converter converts the analog signal into a digital signal compatible with the processor.

15. A web conferencing system according to claim 14 wherein
the codec is configured for video compatibility with one of H.261, H.263 and H.264 protocols, and configured to decompress video using one of H.320, H.323, H.324, MPEG-1.MPEG-2 and MPEG-4 protocols, and
the format converter is configured to provide the digital signal using one of JPGL, VCF, QCF and PGB.

16. A web conferencing method comprising the steps of:
(a) receiving a full-motion video signal from a remote location;
(b) converting the full-motion video signal into a format compatible with a web conferencing system; and
(c) transmitting the converted full-motion video signal to web conference participants using a web conferencing signal.

17. The method of claim 16 wherein
step (a) includes receiving full-motion interactive images of participants in a video conference,
step (b) includes converting the received images into the format compatible with the web conferencing system, and
step (c) includes transmitting the converted images to the web conference participants, wherein the participants of the video conference are different from the web conference participants.

18. The method of claim 17 further including the steps of:
(d) extracting a sound signal after receiving the full-motion interactive images in step (a); and
(e) transmitting the extracted sound signal to the web conference participants using a first network independent of a second network for transmitting the converted full-motion video signal to the web participants.

19. The method of claim 16 wherein
step (b) includes
(i) converting, by using a codec, the received images into a decompressed video signal,
(ii) formatting, by using a format converter, the decompressed video signal into the format compatible with the web conferencing system.

20. The method of claim 19 wherein
step (b) of converting and formatting is performed in a unit located at one location.

21. A web conferencing method comprising the steps of:
(a) connecting a multi-point video conferencing system with a web conference system, wherein (i) the multi-point video conferencing system includes a plurality of codecs communicating with a multi-point controller (MCP), and (ii) the web conference system includes a plurality of terminals communicating with a web conference server;
(b) transmitting a motion video signal to one of the codecs from the MCP; and
(c) converting the motion video signal received by the one codec into a format compatible with the web conference system; and
(d) transmitting the converted motion video signal to the web conference system.

22. The method of claim 21 wherein
step (a) includes connecting the one of the codecs to one of the terminals of the web conference system.

23. The method of claim 22 wherein
step (a) further includes connecting a format converter between the one of the codecs and the one of the terminals; and
step (c) includes converting the motion video signal into the format compatible with the web conference system using the format converter.
